(19) United States
(12) Patent Application Publication
(10) Pub. No.: US 2017/0321789 A1
(43) Pub. Date: Nov. 9, 2017

(54) Mechanical Energy Divider

(71) Applicant: Manuel Martinez, Clinton Township, MI (US)

(72) Inventor: Manuel Martinez, Clinton Township, MI (US)

(21) Appl. No.: 15/585,258

(22) Filed: May 3, 2017

Related U.S. Application Data
(60) Provisional application No. 62/331,615, filed on May 4, 2016.

(51) Int. Cl. F16H 48/20; F16H 48/40; F16H 48/08

(52) U.S. Cl. CPC F16H 48/20; F16H 48/08; F16H 48/40

(57) ABSTRACT

A mechanical energy divider includes an input shaft operably connected to a rotational energy source, an output shaft, and a regulator therebetween. The regulator includes a housing comprising an input gear coupled to the input shaft, an output gear coupled to the output shaft, and a regulator gear rotatably coupled to a first end of an axle that is affixed to the housing. A braking mechanism operably connected to the output shaft for preventing the output shaft from rotating above a set limit. Activation of the braking mechanism causes the regulator shaft to rotate, which causes a mechanical energy storage device comprising a cable and attached weight to raise upward, storing the excess energy as potential energy. The regulator rotates in the opposing direction when the input shaft rotates slower than the set limit, which releases the weight, thereby increasing the speed of the output to the set limit.

### CROSS REFERENCE TO RELATED APPLICATIONS

This application claims the benefit of U.S. Provisional Application No. 62/331,615 filed on May 4, 2016. The above identified patent application is herein incorporated by reference in its entirety to provide continuity of disclosure.

### FIELD OF THE INVENTION

The present invention relates to mechanical energy control systems. More specifically, the present invention provides a mechanical energy divider that maintains the speed of an output shaft at a constant rate via a braking mechanism and a mechanical energy storage device.

### BACKGROUND OF THE INVENTION

Electrical energy is expensive to produce and store. Electrical generators typically have an ideal rotational speed that allows them to produce a maximum amount of energy. If a wind turbine or other power source causes the generator to rotate too quickly, only a fraction of the rotational energy of the input is converted into electrical energy and the remaining rotational energy is lost. Conversely, if the input rotational motion is less than the ideal rotational speed of the generator, a less than ideal amount of electricity is generated. Few devices exist for storing excess energy which may be produced by a power source. As a result, any excess of energy is lost and is not used to generate electricity. Thus, a mechanical energy storage system is desired for allowing the user to capture any excess energy produced by a power source and store it for later use.

Devices have been disclosed in the known art that relate to mechanical energy storage systems. These include devices that have been patented and published in patent application publications. However, these devices have several drawbacks. The devices in the known art include means for generating energy based on mechanical principles, but most lack a means for storing excess input energy for later use. The devices in the known art that do include a means for storing excess input energy still have numerous problems. These devices must be turned off and disconnected in order to be recharged, and often require additional complex transmission mechanisms to switch between energy storage and energy release. Further, the devices in the known art fail to provide an energy storage device that can be connected to an input source and an output that is capable of maintaining a constant rate of output motion.

In light of the devices disclosed in the prior art, it is submitted that the present invention substantially diverges in design elements from the prior art and consequently it is clear that there is a need in the art for an improvement to existing mechanical energy storage devices. In this regard the instant invention substantially fulfills these needs.

### SUMMARY OF THE INVENTION

In view of the foregoing disadvantages inherent in the known types of energy dividers now present in the prior art, the present invention provides a mechanical energy divider wherein the same can be utilized for providing convenience for the user when storing excess input energy in order to increase or reduce the speed of an output shaft to maintain it a constant speed. The mechanical energy divider comprises an input shaft operably connected to a rotational energy source. The input shaft extends into a regulator comprising a housing, the housing comprising an input gear coupled to the input shaft, an output gear, and a regulator gear rotatably coupled to a first end of an axle, wherein the second end of the axle is fixedly secured to an inner surface of the housing, and wherein the input gear, the output gear, and the regulator gear are operably coupled to one another. An output shaft coupled to the output gear is further operably connected to a braking mechanism that is configured to activate if the rotational speed of the output shaft reaches a set limit. A mechanical energy storage device is operably connected to the regulator and comprises a cable having a first end connected to the regulator housing and a second end having a weight connected thereto.

One object of the present invention is to provide a mechanical energy divider configured to maintain the rotational speed of an output shaft at a constant rate.

Another object of the present invention is to provide a mechanical energy divider that utilizes stored potential energy to accelerate an output shaft to an optimal rotational speed.

A further object of the present invention is to provide a mechanical energy divider that utilizes a braking system in order to decelerate an output shaft to an optimal rotational speed.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of the components of the mechanical energy divider.

FIG. 2 shows a cut-away view of the regulator component mechanical energy divider.

FIG. 3 shows a cross-sectional view of the regulator component of the mechanical energy divider.

FIG. 4 shows a perspective view of the mechanical energy divider.

### DETAILED DESCRIPTION OF THE INVENTION

Reference is made herein to the attached drawings. Like reference numerals are used throughout the drawings to depict like or similar elements of the mechanical energy divider. For the purposes of presenting a brief and clear description of the present invention, the preferred embodiment will be discussed as used for controlling the speed of an output shaft while storing excess energy from the input shaft. The figures are intended for representative purposes only and should not be considered to be limiting in any respect.

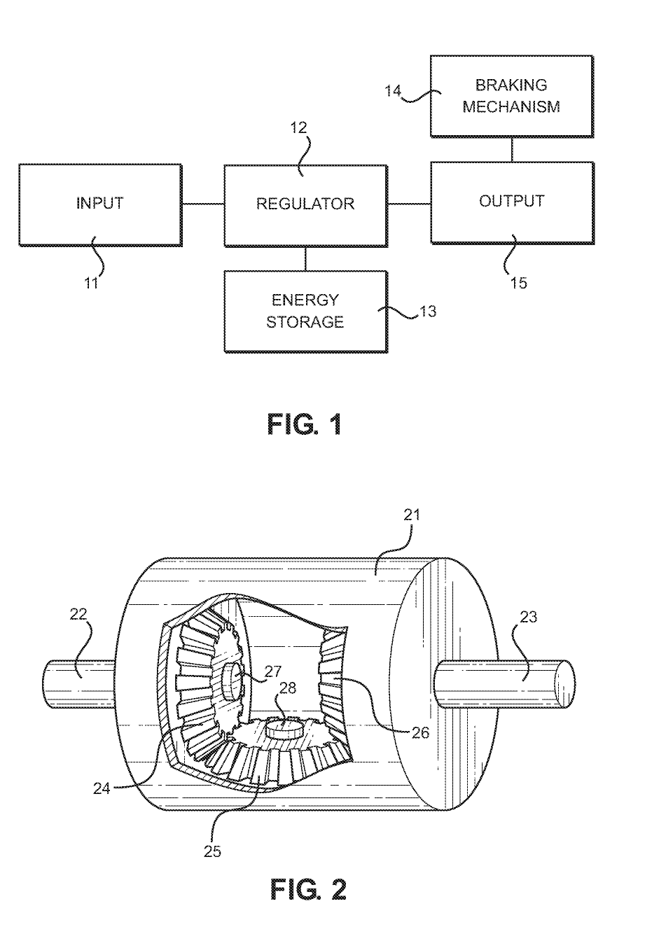

Referring now to FIG. 1, there is shown a diagram of the components of the mechanical energy divider. The mechanical energy divider includes a regulator 12 that is operably connected to an input 11 and an output 15. The input 11 can be any source of rotational energy, such as a wind turbine, a steam turbine, or the like, which is connected to a shaft that extends into a housing of the regulator 12. The output 15 includes a shaft that extends out of an opposing end of the housing of the regulator 12. The output 15 can be operably connected to an electrical generator, so that rotational energy of the output 15 can be converted into electrical energy.

A braking mechanism 14 is operably connected to the output 15. The braking mechanism 14 is configured to activate and reduce the rotational speed of the output 15 if the output 15 reaches an upper set limit. The braking mechanism 14 can include a sensor configured to detect the rotational speed of the output and a controller configured to activate the braking mechanism when the set limit is reached. The braking mechanism 14 can include a magnetic brake, a brake pad, or any other device that can be configured to reduce the rotational speed of a shaft.

An energy storage 13 is operably connected to the regulator 12. When the braking mechanism 14 is activated to slow the output 15, the excess rotational energy of the output 15 is stored by the energy storage 13, which can be a potential energy storage device include a weight coupled to the regulator. In alternate embodiments, the energy storage 13 can be a spring operably connected to the regulator. The energy storage 13 is further configured to release and provide additional energy to the output 15 when the output 15 has a rotational speed that is below a lower set limit. In this way, the speed of the output 15 is maintained at a near-constant rate, which provides optimal efficiency when convert rotational energy into electrical energy.

Referring now to FIG. 2, there is shown a cut-away view of the regulator component mechanical energy divider. The regulator comprises a housing 21 having an input shaft 22 and an output shaft 23 extending through opposing sides thereof. The input shaft is 22 is operably connected to a rotational energy source and the output shaft 23 is operably connected to an electric generator.

An input gear 24 is coupled to the input shaft 22, and an output gear 26 is coupled to the output shaft 23. A regulator gear 25 is disposed and intermeshed between the input and output gears 24, 26 such that it is perpendicular thereto. The regulator gear 25 is rotatably coupled to a regulator axle 28 which is fixedly attached to the housing 21. The input gear 24, regulator gear 25, and output gear 26 are intermeshed such that rotation of the input gear 24 causes rotation of the regulator gear 25, which in turn causes rotation of the output gear 26. In the illustrated embodiment, the housing 21 is cylindrical. However, other embodiments may include other shapes. In an alternate embodiment, the input gear 24, output gear 26, and regulator gear 25 may be configured and arranged in a planetary gear system.

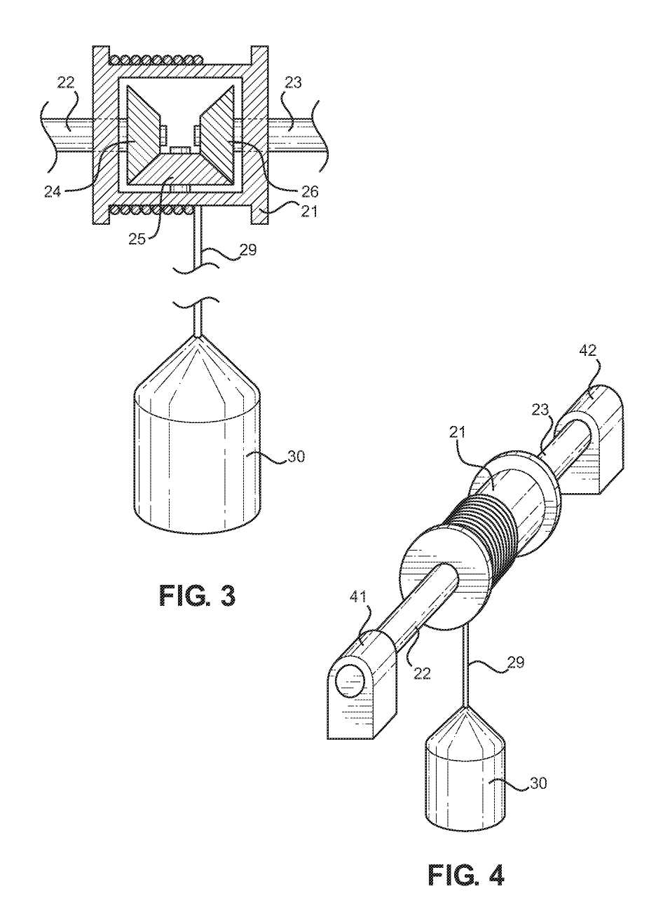

Referring now to FIGS. 3 and 4, there is shown a cross-sectional view of the regulator component of the mechanical energy divider and a perspective view of the mechanical energy divider, respectively. The mechanical energy storage device includes a weight 30 connected to a cable 29, which is connected at an opposing end to the regulator housing 21. When the rotational speed of the input shaft 22 equals the rotational speed of the output shaft 23, the regulator housing 21 remains stationary. A difference in rotational speed between the input and output shafts 24, 26 results in the regulator housing 21 rotating, the direction of rotation depending on which shaft has the greater rotational speed.

When the speed of the output shaft 23 reaches an upper set limit, the braking mechanism 42 is configured to activate, causing the speed of the output shaft 23 to be reduced. The torque created by the greater rotational speed of the input shaft 22 when compared to the rotational speed of the output shaft 23 causes the input gear 24 to exert a downward force on the regulator gear 25, which in turn causes the regulator housing 21 to rotate in a first direction. The cable 29 is wound around the housing 21 and the weight 30 is raised upward, effectively storing the excess rotational energy as potential energy.

When the rotational speed of the output shaft 23 falls below a lower set limit due to a low rotational speed of the input shaft 22, the regulator gear 25 exerts an upward force on the input gear 24. The upward force causes the regulator housing 21 to rotate in a second direction opposing the first direction of rotation. When the regulator housing 21 rotates in the second direction, the weight 30 is lowered, and the input gear and output gear 24, 26 rotate due to rotation of the regulator gear 25 that is caused by the rotation of the housing 21 as the weight 30 is lowered. A one-way rotational mechanism 41 such as a ratchet is operably connected to the input shaft 22 and is configured to permit the input shaft 22 to rotate in only one direction. The output gear 26 is then accelerated as the weight 30 is lowered, which increases the rotational speed of the output shaft 23.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mechanical energy divider, comprising:
an input shaft operably connected to a rotational energy source;
a regulator comprising a housing, the housing comprising an input gear coupled to the input shaft, an output gear, and a regulator gear, the regulator gear rotatably coupled to a first end of an axle, wherein the second end of the axle is fixedly secured to an inner surface of the housing, and wherein the input gear, the output gear, and the regulator gear are operably coupled to each another;
an output shaft coupled to the output gear;
a braking mechanism operably connected to the output shaft; and
a mechanical energy storage device comprising a cable having a first end connected to the regulator and a second end having a weight connected thereto.

2) The mechanical energy divider of claim 1, wherein the regulator is configured to rotate in a first direction when a rotational speed of the input shaft is greater than a rotational speed of the output shaft.

3) The mechanical energy divider of claim 1, wherein the regulator is configured to rotate in a second direction when a rotational speed of the input shaft is less than a rotational speed of the output shaft.

4) The mechanical energy divider of claim 1, wherein the regulator is configured to remain stationary when a rotational speed of the input shaft is equal to a rotational speed of the output shaft.

5) The mechanical energy divider of claim 1, wherein the input shaft is configured to rotate in only one direction.

6) The mechanical energy divider of claim 1, wherein the braking system is configured to activate and reduce the speed of the output shaft if the speed of the output shaft is above a set limit.

7) The mechanical energy divider of claim 5, wherein the regulator housing is configured to rotate when the braking mechanism is activated.

8) The mechanical energy divider of claim 1, wherein the rotational energy source is a motor.

9) The mechanical energy divider of claim 1, wherein the output shaft is operably connected to an electric generator.

10) The mechanical energy divider of claim 1, wherein the regulator housing is cylindrical.
